(19) United States
(12) Patent Application Publication
(10) Pub. No.: US 2006/0066612 A1
(43) Pub. Date: Mar. 30, 2006

(54) Method and system for real time image rendering

(76) Inventors: Herb Yang, Edmonton (CA); Yi Xu, West Lafayette, IN (US)

Correspondence Address: Ralph A. Dowell of DOWELL & DOWELL P.C., 2111 Eisenhower Ave, Suite 406, Alexandria, VA, 22314, US

(21) Appl. No.: 11/231,760

(22) Filed: Sep. 22, 2005

Related U.S. Application Data
(60) Provisional application No. 60/612,249, filed on Sep. 23, 2004.

(51) Int. Cl. G06T 15/00

(52) U.S. Cl. 345/419

(57) ABSTRACT

An image-based rendering system and method for rendering a novel image from several reference images. The system includes a pre-processing module for pre-processing at least two of the reference images and providing pre-processed data; a view synthesis module connected to the pre-processing module for synthesizing an intermediate image from the at least two of the reference images and the pre-processed data; and, an artifact rejection module connected to the view synthesis module for correcting the intermediate image to produce the novel image.

### CROSS-REFERENCE

This application claims priority from U.S. Provisional Application Ser. No. 60/612,249 filed on Sep. 23, 2004.

### FIELD OF THE INVENTION

The invention relates to an improved system and method for capturing and rendering a three-dimensional scene.

### BACKGROUND OF THE INVENTION

A long-term goal of computer graphics is to generate photo-realistic images using computers. Conventionally, polygonal models are used to represent 3D objects or scenes. However, during the pursuit of photo-realism in conventional polygon-based computer graphics, polygonal models have become very complex. The extreme case is that some polygons in a polygonal model are smaller than a pixel in the final resulting image.

An alternative approach to conventional polygon-based computer graphics is to represent a complex environment using a set of images. This technique is known as image-based rendering (IBR) in which the objective is to generate novel views from a set of reference views. The term “image” in IBR includes traditional color images and range (i.e. depth) images which are explicit but have less precise geometric information.

Using images as the rendering primitives in computer graphics produces a resulting image that is a natural photo-realistic rendering of a complex scene because real photographs are used and the output color of a pixel in the resulting image comes from a pixel in the reference image or a combination of a group of such pixels. In addition, with IBR, the rendering rate depends on output resolution instead of on polygonal model complexity. For instance, given a highly complex polygonal model that has several million polygons, if the output resolution is very small, for example, and requires several thousand pixels in the output image, rendering these pixels from input images is typically more efficient than rasterizing a huge number of polygons.

Early attempts in IBR include the light field [1] and lumigraph [2] methods. Both of these methods parameterize the sampling rays using four parameters. For an arbitrary viewpoint, appropriate rays are selected and interpolated to generate a novel view of the object. Both methods depend on a dense sampling of the object. Hence, the storage needed for the resulting representations can be quite large even after compression.

To solve this problem, many researchers use geometric information to reduce the number of image samples that are required for representing the object. Commonly used geometric information includes a depth map wherein each element defines the distance from a physical point in the object to the corresponding point in the image plane. By using images with depth maps, a 3D image warping equation [3] can be employed to generate novel views. The ensuing visibility problem can be solved using the occlusion-compatible rendering approach proposed by McMillan and Bishop [4].

Oliveira and Bishop [5] use the 3D image warping equation to render image-based objects. They represent an object using perspective images with depth maps at six faces of a bounding cube. Their implementation can achieve an interactive rendering rate. However, image warping is computationally intensive which makes achieving a high frame rate challenging.

To accelerate the image warping process, Oliveira et al. [6] propose a relief texture mapping method that decomposes 3D image warping into a combination of image pre-warping and texture mapping. Since the texture mapping function is well supported by current graphics hardware, this method can speed up 3D image warping. Oliveira et al. propose to represent an object using six relief textures, each of which is a parallel projected image with a depth map at each face of the bounding box.

Kautz and Seidel [7] also use a representation similar to that of Oliveira et al. for rendering image-based objects using depth information. Their algorithm is based on a hardware-accelerated displacement mapping method, which slices through the bounding volume of an object and renders the correct pixel set on each of the slices. This method is purely hardware-based and can achieve a high frame rate. However, it cannot generate correct novel views at certain view angles and cannot be used to render objects with high depth complexity.

### SUMMARY OF THE INVENTION

The invention may be used to render a scene from images that are captured using a set of cameras. The invention may also be used to synthesize accurate novel views that are unattainable based on the location of any one camera in a set of cameras by using an inventive hardware-based backward search process. The inventive hardware-based backward search process is more accurate than previous forward mapping methods. Furthermore, embodiments of the invention may run at a highly interactive frame rate using current graphics hardware.

In one aspect, at least one embodiment of the invention provides an image-based rendering system for rendering a novel image from several reference images. The system comprises a pre-processing module for pre-processing at least two of the several reference images and providing pre-processed data; a view synthesis module connected to the pre-processing module for synthesizing an intermediate image from the at least two of the reference images and the pre-processed data; and, an artifact rejection module connected to the view synthesis module for correcting the intermediate image to produce the novel image.

In another aspect, at least one embodiment of the invention provides an image-based rendering method for rendering a novel image from several reference images. The method comprises:

a) pre-processing at least two of the several reference images and providing pre-processed data;

b) synthesizing an intermediate image from the at least two of the reference images and the pre-processed data; and,

c) correcting the intermediate image and producing the novel image.

### BRIEF DESCRIPTION OF THE DRAWINGS

For a better understanding of the invention and to show more clearly how it may be carried into effect, reference will now be made, by way of example only, to the accompanying drawings which show at least one exemplary embodiment of the invention and in which:

FIG. 1a illustrates the concept of disparity for two parallel views with the same retinal plane;

FIG. 1b illustrates the relation between disparity and depth;

FIG. 1c shows a color image and its disparity map;

FIG. 2 is a 2D illustration of the concept of searching for the zero-crossing point in one reference image;

FIG. 3 is a 2D illustration of the stretching “rubber sheet” problem;

FIG. 4 shows a rendering result using Gong and Yang's disparity-matching based view interpolation algorithm;

FIG. 5 shows a block diagram of a pipeline representation of a current graphics processing unit (GPU);

FIG. 6 shows a block diagram of an exemplary embodiment of an image-based rendering system in accordance with the invention;

FIG. 7 shows a block diagram of an exemplary embodiment of an image-based rendering method in accordance with the invention;

FIG. 8 is a 2D illustration of the bounding points of the search space used by the system of FIG. 6;

FIG. 9 is an illustration showing epipolar coherence;

FIG. 10 is an illustration showing how the visibility problem is solved with the image-based rendering system of the invention;

FIG. 11 is a 2D illustration of a zoom effect that can be achieved with the image-based rendering system of the invention;

FIGS. 12a-h show four reference views with corresponding disparity maps (the input resolution is 636×472 pixels);

FIG. 13a shows the linear interpolation of the four reference images of FIGS. 12a, 12b, 12e and 12f;

FIG. 13b shows a rendered image based on the four reference images of FIGS. 12a, 12b, 12e and 12f using the image-based rendering system of the invention;

FIG. 14a, 14b, 14g and 14h show four reference views and FIGS. 14c, 14d, 14e and 14f are four synthesized views inside the space bounded by the four reference views;

FIGS. 15a and 15b show rendering results using the inventive system for a scene using different sampling rates (FIG. 15b is generated from a more sparsely sampled scene);

FIGS. 16a-h show four reference views with corresponding disparity maps (the input resolution is 384×288);

FIGS. 17a, 17b, 17g and 17h are four reference views and FIGS. 17c, 17d, 17e and 17f are four corresponding synthesized views inside the space bounded by the four reference views (the output resolution is 384×288);

FIG. 18a shows a linear interpolation result in the middle of the four reference views of FIGS. 16a, 16b, 16e and 16f (the output resolution is 384×288);

FIG. 18b shows the resulting rendered image using the image-based rendering system of the invention and the four reference views of FIGS. 16a, 16b, 16e and 16f (the output resolution is 384×288);

FIGS. 19a-d show intermediate results obtained using different numbers of rendering passes;

FIGS. 20a and 20b show rendering results before filling the holes and after filling the holes respectively (the holes are highlighted using blue rectangles);

FIGS. 21a and 21b show zoom-in results for the Santa Claus scene and the head and lamp scene respectively; and,

FIGS. 22a-c show a novel view, a ground truth view and the difference image between them respectively.

### DETAILED DESCRIPTION OF THE INVENTION

It will be appreciated that for simplicity and clarity of illustration, numerous specific details are set forth in order to provide a thorough understanding of the invention. However, it will be understood by those of ordinary skill in the art that the invention may be practiced without these specific details. In other instances, well-known methods, procedures and components have not been described in detail so as not to obscure the invention.

Acquiring accurate depth information for a real scene or object is difficult and to render a real scene without accurate depth information and with sparse sampling can be problematic. To solve this problem, implicit geometry, such as point correspondence or disparity maps, has been used in several previous IBR techniques. For example, the view interpolation method reconstructs in-between views (i.e. a view from a viewpoint between the two or more reference viewpoints) by interpolating the nearby images based on dense optical flows, which are dense point correspondences in two reference images [8]. In addition, the view morphing approach can morph between two reference views [9] based on the corresponding features that are commonly specified by human animators. These two methods depend on either dense and accurate correspondence between reference images or human input and thus cannot synthesize novel views automatically from reference images.

To automatically generate in-between views, several techniques use disparity maps. A disparity map defines the correspondence between two reference images and can be established automatically using computer vision techniques that are well known to those skilled in the art. If a real scene can be reconstructed based on the reference images and the corresponding disparity maps only, it can be rendered automatically from input images. For example, view synthesis using the stereo-vision method [10] involves, for each pixel in the reference image, moving the pixel to a new location in the target view based on its disparity value. This is a forward mapping approach, which maps pixels in the reference view to their desired positions in the target view. However, forward mapping cannot guarantee that all of the pixels in the target view will have pixels mapped from the reference view. Hence, it is quite likely that holes will appear in the final result.

To address this problem, a backward-rendering approach can be adopted. For each pixel in the target view, a backward-rendering approach searches for its matching pixel in the reference images. For example, Gong and Yang's disparity-matching based view interpolation algorithm [11] uses a backward search to find the color for a pixel in the novel view from four nearby reference views based on pre-estimated disparity maps. Their approach can generate physically correct novel views automatically from input views. However, it is computationally intensive and the algorithm runs very slowly.

The invention provides a system and method for a backward-rendering approach with increased speed compared to Gong and Yang's backward-rendering approach. The invention provides a system and method for a hardware-based (which in one exemplary embodiment may be GPU-based) backward-rendering technique (i.e. the GBR method) that may be implemented on a graphics processing unit (GPU). Parallel per-pixel processing is available in a GPU. Accordingly, a GPU may be used to accelerate backward rendering if the rendering process for each pixel is independent. The invention may use the parallel processing ability of a GPU to achieve high performance. In particular, the inventive method includes coloring a pixel in a novel view by employing a backward search process in each of several nearby reference views to select the best pixel. Since the search process for each pixel in the novel view is independent, the single instruction multiple data (SIMD) architecture of current GPUs may be used for acceleration.

Advantageously, data acquisition for the invention is simple since only images are required. The GBR method can generate accurate novel views with a medium resolution at a high frame rate from a scene that is sparsely sampled by a small number of reference images. The invention uses pre-estimated disparity maps to facilitate the view synthesis process.

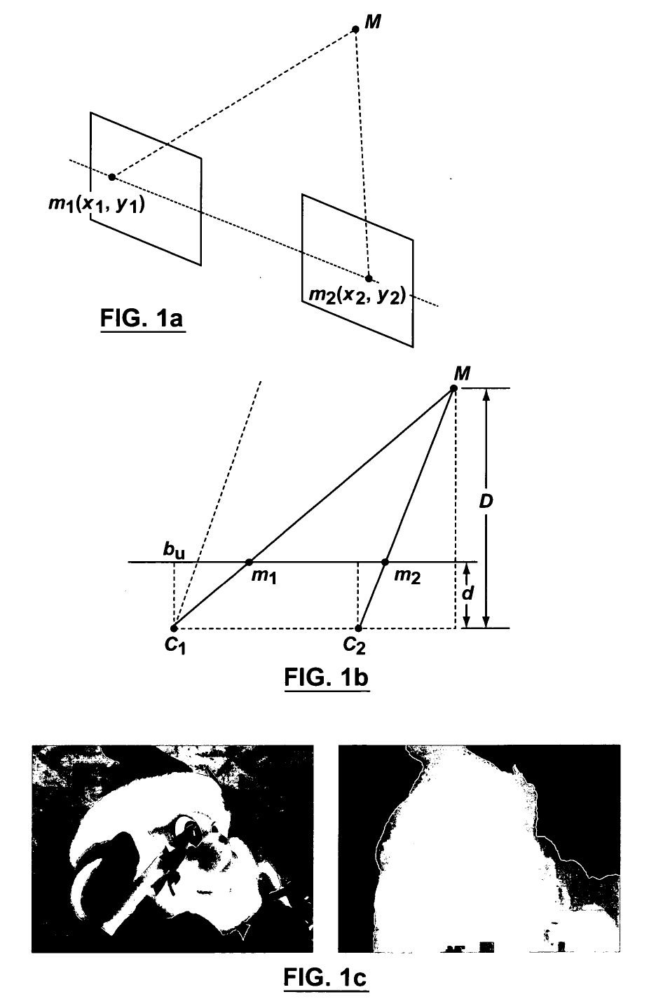

The GPU-based backward rendering method of the invention may be categorized as an IBR method that uses positional correspondences in input images. The positional correspondence used in the invention may be disparity information which can be automatically estimated from the input images. Referring now to FIG. 1a, for two parallel views and with the same retinal plane, the disparity value is the distance x2-x1 given a pixel ml with coordinates (x1, y1) in the first image and a corresponding pixel m2 with coordinates (x2, y2) in the second image.

Referring now to FIG. 1b, shown therein is a graphical representation of the relation between disparity and depth. C1 and C2 are two centers of projection and m1 and m2 are two projections of the physical point M onto two image planes. The line C₁bᵤ is parallel to the line C₂m₂. Therefore, the distance between points bᵤ and m₁ is the disparity (i.e. disp) which is defined as shown in equation 1 based on the concept of similar triangles.

$$\frac{\vert disp \vert}{\vert {b}_{u} {m}_{2} \vert} = \frac{\vert {C}_{1} {m}_{1} \vert}{\vert {C}_{1} M \vert} ⇒ \frac{\vert disp \vert}{\vert {C}_{1} {C}_{2} \vert} = \frac{d}{D} ⇒ \vert disp \vert = \frac{d \times \vert {C}_{1} {C}_{2} \vert}{D} \qquad ( 1 )$$

In equation 1, d is the distance from the center of projection to the image plane and D is the depth from the physical point M to the image plane. As can be seen, the disparity value of a pixel in the reference view is inversely proportional to the depth of its corresponding physical point. Disparity values can be estimated using various computer vision techniques [12, 13]. FIG. 1c shows a color image and its corresponding disparity map estimated using a genetic based stereo algorithm [12]. The whiter the pixel is in the disparity map, the closer it is to the viewer.

The disparity map represents a dense correspondence and contains a rough estimation of the geometry in the reference images, which is very useful for IBR. One advantage of using disparity maps is that they can be estimated from input images automatically. This makes the acquisition of data very simple since only images are required as input.

Gong and Yang's disparity-matching based view interpolation method [11] involves capturing a scene using the so-called camera field, which is a two dimensional array of calibrated cameras mounted onto a support surface. The support surface can be a plane, a cylinder or any free form surface. A planar camera field, in which all the cameras are mounted on a planar surface and share the same image plane, is described below.

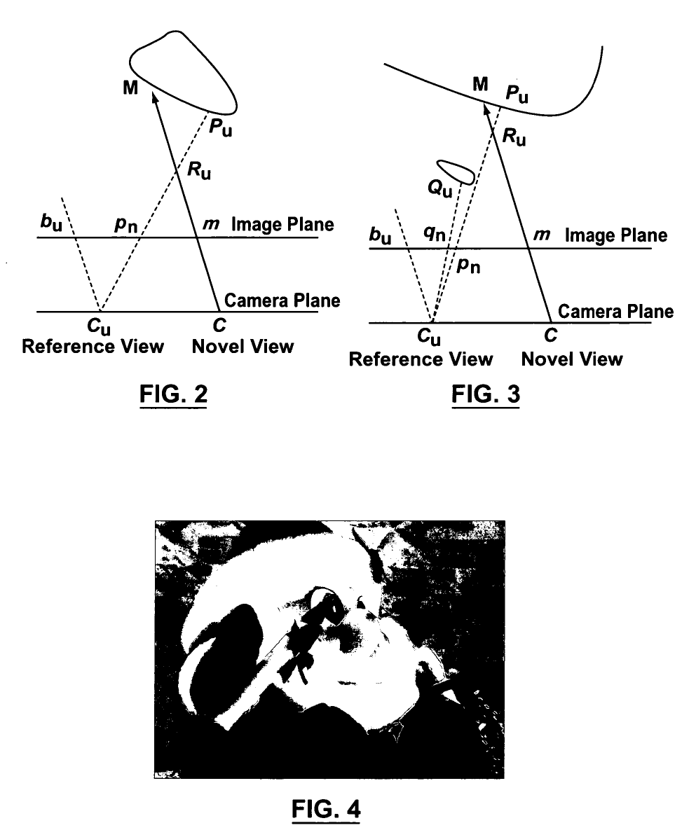

Prior to rendering a scene, Gong and Yang's method involves pre-computing a disparity map for each of the rectified input images using a suitable method such as a genetic-based stereo vision algorithm [12]. In this case, eight neighboring images are used to estimate the disparity map of a central image. The disparity value is defined according to equation 2:

$$δ ( {p}_{u} ) = \frac{\vert {C}_{u} {p}_{u} \vert}{\vert {C}_{u} {p}_{u} \vert} \qquad ( 2 )$$

in which Cᵤ is the center of projection of the reference view, pᵤ is a pixel in the reference image, and Pᵤ is the corresponding physical point in the 3D space (see FIG. 2). Good novel views can be generated even when the estimated disparity maps are inaccurate and noisy [11].

The basic idea in Gong and Yang's method is to search for the matching pixel in several nearby reference views; preferably four nearby reference views. FIG. 2 shows a 2D illustration of the camera and image plane configuration. C is the center of projection of the novel view. The cameras C and Cᵤ are on the same camera plane and they also share the same image plane. The rays Cm and Cᵤbᵤ are parallel rays. For each pixel m in the novel view, its corresponding physical point M will be projected onto the epipolar line segment bᵤm in the reference image. Gong and Yang's method searches for this projection. For each pixel pᵤ on the segment bᵤm, the length of CᵤRᵤ may be computed using equation 3 [11].

$$\frac{\vert {C}_{u} {p}_{u} \vert}{\vert {C}_{u} {R}_{u} \vert} = \frac{\vert {b}_{u} {p}_{u} \vert}{\vert {C}_{u} C \vert} ⇒ \vert {C}_{u} {R}_{u} \vert = \vert {C}_{u} {p}_{u} \vert \times \frac{\vert {C}_{u} C \vert}{\vert {b}_{u} {p}_{u} \vert} \qquad ( 3 )$$

The length of CᵤPᵤ can also be computed based on pixel pᵤ's pre-estimated disparity value δ(pᵤ) [11] as shown in equation 4.

$$δ ( {p}_{u} ) = \frac{\vert {C}_{u} {p}_{u} \vert}{\vert {C}_{u} {P}_{u} \vert} ⇒ \vert {C}_{u} {P}_{u} \vert = \vert {C}_{u} {p}_{u} \vert \times \frac{1}{δ ( {p}_{u} )} \qquad ( 4 )$$

If the pixel pᵤ in the reference image is the projection of the physical point M, then |CᵤRᵤ| should be equal to |CᵤPᵤ|, i.e. the following evaluation function F(pᵤ) shown in equation 5 should be equal to zero [15].

$$F ( {p}_{u} ) = δ ( {p}_{u} ) - \frac{\vert {b}_{u} {p}_{u} \vert}{\vert {C}_{u} C \vert} \qquad ( 5 )$$

Accordingly, searching for the projection of M on the epipolar line segment bᵤm is equivalent to finding the zero-crossing point of the evaluation function F(pᵤ). The value δ(pᵤ) is referred to as the estimated disparity value and the value

$$\frac{\vert {b}_{u} {p}_{u} \vert}{\vert {C}_{u} C \vert}$$

as the observed disparity value.

For each pixel m in the novel view, Gong and Yang's method searches for the zero-crossing point along the epipolar line from the point m to the point bᵤ in the reference image. The visibility problem is solved by finding the first zero-crossing point. This is based on the following observation: if a point M on the ray Cm is closer to C, it will be projected onto a point closer to m in the reference image. If the search fails in the current reference view, the original method searches other reference views and composes the results together.

Since the evaluation function F(pᵤ) is a discrete function, it may not be able to find the exact zero-crossing point. Linear interpolation may be used to approximate the continuous function. However, this will cause a stretching effect, between the foreground and background objects. This problem is known as the “rubber sheet” problem to those skilled in the art and is illustrated in FIG. 3. Pixels pᵤ and qᵤ are consecutive pixels on the epipolar line segment mbᵤ. Their actual corresponding physical points are Pᵤ and Qᵤ, respectively, which are on the two distinct objects. The value of F(pᵤ) is negative while the value of F(qᵤ) is positive. The linear interpolation of the two values will generate a wrong color for the pixel m. A threshold may be used to detect these kind of discontinuities and to discard false zero-crossing points. FIG. 4 shows a result obtained using Gong and Yang's method. Unfortunately, this method is computationally intensive and runs very slowly.

For each of the pixels in the target view, a backward rendering approach searches for the best matching pixel in the reference images. It can be described as the following function in equation 6:
p=F(q) (6)
where q is a pixel in the target image and p is q's corresponding pixel in the reference image.

Backward methods do not usually generate a novel image with holes because for each pixel in the target view, the backward method searches for a matching pixel in the reference images. In this way, every pixel can be determined unless it is not visible in any of the reference views. Accordingly, unlike a simple forward mapping from a source pixel to a target pixel, backward methods normally search for the best match from a group of candidate pixels. This can be computationally intensive if the candidate pool is large.

During the last few years, the advent of graphics hardware has made it possible to accelerate many computer graphics techniques, which include image-based rendering, volume rendering, global illumination, color image processing, etc. Currently, programmable graphics hardware (GPU) is very popular and has been used to accelerate existing graphics algorithms. Since the GPU's are powerful parallel vector processors, it would be beneficial to alter a backward rendering IBR method to exploit the single instruction multiple data (SIMD) [14] architecture.

Over the last several years, the capability of GPUs has increased more rapidly than general purpose CPUs. The new generation of GPUs can be considered as a powerful and flexible parallel streaming processor. The current GPUs include a programmable per-vertex processing engine and a per-pixel processing engine which allow a programmer to implement various calculations on a graphics card on a per-pixel level including addition, multiplication, and dot products. The operations can be carried out on various operands, such as texture fragment colors and polygon colors. General-purpose computation can be performed in the GPUs.

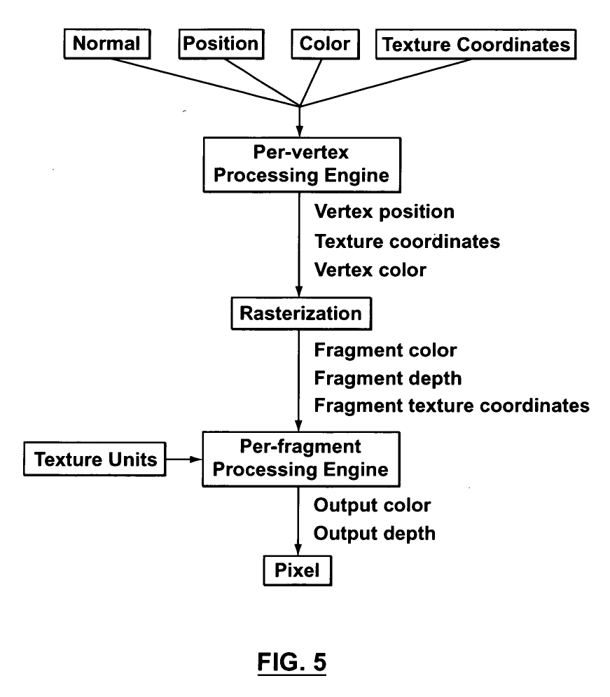

Referring now to FIG. 5, shown therein is a block diagram of a pipeline representation of a current GPU. The rendering primitives are passed to the pipeline by the graphics application programming interface. The per-pixel vertex processing engine, the so called vertex shaders (or vertex programs as they are sometimes referred to) are then used to transform the vertices and compute the lighting for each vertex. The rasterization unit then rasterizes the vertices into fragments which are generalized pixels with attributes other than color. The texture coordinates and vertex colors are interpolated over these fragments. Based on the rasterized fragment information and the input textures, the per-pixel fragment processing engine, the so called pixel shaders (or pixel programs as they are sometimes referred to) are then used to compute the output color and depth value for each of the output pixels.

For general-purpose computation, GPUs may be used as parallel vector processors. The input data is formed and copied into texture units and then passed to the vertex and pixel shaders. With per-pixel processing capability, the shaders can perform calculations on the input textures. The resulting data is rendered as textures into a frame buffer. In this kind of grid-based computation, nearly all of the calculations are performed within the pixel shaders.

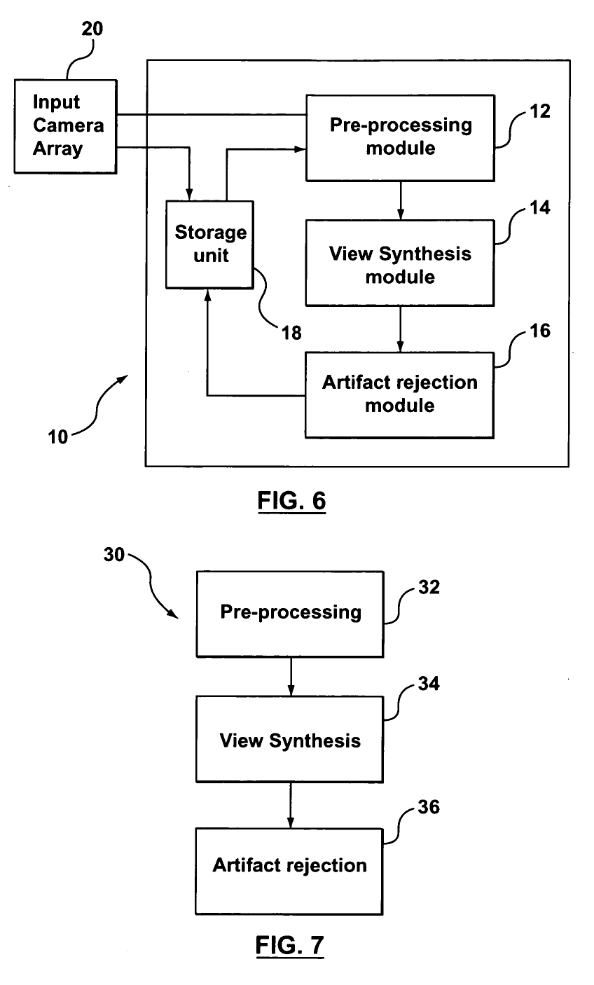

Referring now to FIG. 6, shown therein is a block diagram of an exemplary embodiment of an image-rendering system 10 for rendering images in accordance with the present invention. The image-based rendering system 10 includes a pre-processing module 12, a view synthesis module 14 and an artifact rejection module 16 connected as shown. The image-based rendering system 10 may further include a storage unit 18 and an input camera array 20. The input camera array 20 and the storage unit 18 may be optional depending on the configuration of the image-rendering system 10.

Pre-estimated disparity maps are calculated by the pre-processing module 12 for at least two selected reference images from the set of the reference images (i.e. input images). The pre-processing module 12 further provides an array of offset values and an array of observed disparity values for each of the reference images based on the location of the novel view with respect to the reference images. The disparity maps, the array of observed disparity values and the array of offset values are referred to as pre-processed data. The pre-processed data and the same reference images are provided to the view synthesis module 14 which generates an intermediate image by applying a backward search method described in further detail below. The view synthesis module 14 also detects scene discontinuities and leaves them un-rendered as holes in the intermediate results. The intermediate image is then sent to the artifact rejection module 16 for filling the holes to produce the novel image.

The image-based rendering system 10 has improved the performance of the previous image-based backward rendering method [11] by addressing several issues which include tightly bounding the search space, coherence in epipolar geometry, and artifact removal methods.

Referring now to FIG. 7, shown therein is a block diagram of an image-based rendering method 30 in accordance with the invention. The first step 32 in the image-based rendering method 30 is to pre-process the input reference images that are provided by the input camera array 20 or the storage unit 18. The intermediate image is then synthesized in step 34. Artifact rejection is then performed in step 36 which fills the holes in the intermediate image to produce the novel image. The processing that occurs in each of these steps will now be discussed.

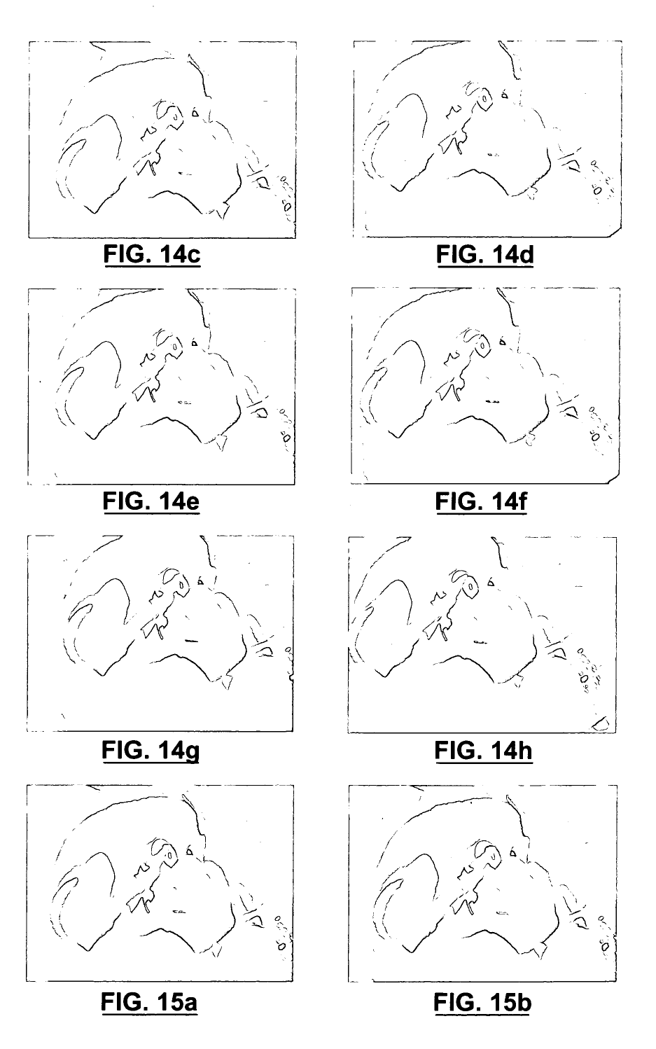

For each pixel in the novel view, the view synthesis module 14 searches for the zero-crossing point in each of several nearby reference views, until a zero-crossing point is located. The reference view whose center of projection has a smaller distance to the novel center of projection is searched earlier. In this way, the search can be performed efficiently, especially for novel views that are very close to one of the reference views. In such a case, the length of CᵤC is very small, and thus the search segment is very short. For example, when rendering a Santa Claus scene with an output resolution of 318×236, the frame rate for a novel view, which is in the middle of four reference views, is about 51 frames per second. However, when the viewpoint is very close to the upper left reference view (see FIG. 14a), the frame rate increases to about 193 frames per second.

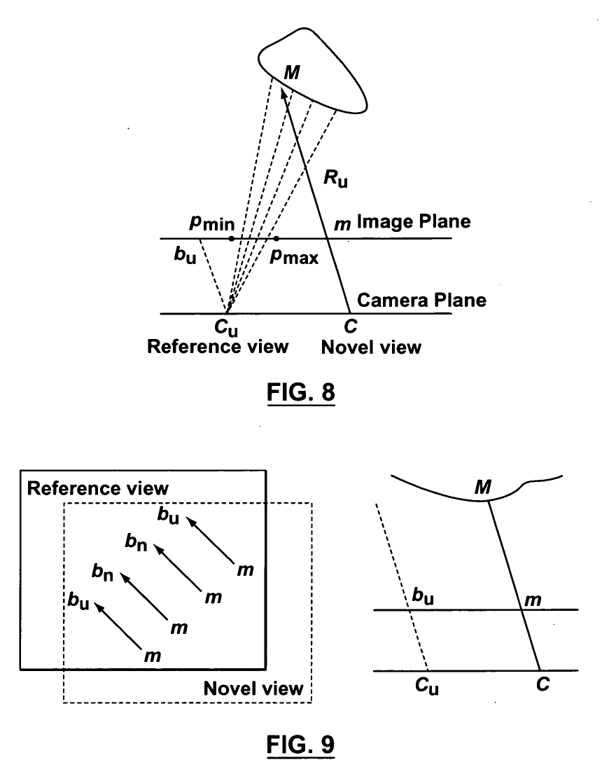

Previous disparity-matching based image-based rendering methods [11] searched for the zero-crossing point from point m to point bᵤ along the epipolar line (see FIG. 8). Since the pixel pᵤ is between the points bᵤ and m on the segment, the observed disparity value

$${δ}_{observed} ( {p}_{u} ) = \frac{\vert {b}_{u} {p}_{u} \vert}{\vert {C}_{u} C \vert}$$

is within the range of [0, 1] and decreases from point m to point bᵤ. However, the range of the pre-estimated disparity values may be a subset of [0, 1]. Thus, for a particular pixel on the epipolar line segment mbᵤ, if its observed disparity value is larger (or smaller) than the maximum (or minimum) pre-estimated disparity value (recall that estimated disparity is

$$δ ( {p}_{u} ) = \frac{\vert {C}_{u} {p}_{u} \vert}{\vert {C}_{u} {P}_{u} \vert} \text{),}$$

then it cannot be a projection of the physical point M. Accordingly, to solve this problem, the pre-processing module 12 may establish a tighter bound for the search space. The bound is defined as a global bound since all of the pixels in the novel image have the same bound.

For a given reference image, the pre-processing module 12 first finds the global maximum and minimum estimated disparity values δₘₐₓ and δₘᵢₙ from the disparity map and then calculates the bounding points pₘₐₓ and pₘᵢₙ on the epipolar line segment. In practice, a value slightly larger (or smaller) than δₘₐₓ (or δₘᵢₙ) by ε is used to compensate for numerical errors (ε may be on the order of 0.01 to 0.05 and may preferably be 0.03). A “search pixel” is then moved along the epipolar line from point m to bᵤ, one pixel at a time. For each pixel location, the observed disparity value for the search pixel is computed

$$( i . e . {δ}_{observed} ( {p}_{u} ) = \frac{\vert {b}_{u} {p}_{u} \vert}{\vert {C}_{u} C \vert} ) ,$$

until a pixel is reached whose observed disparity value is smaller than δₘₐₓ. Then the previous pixel on the epipolar line segment is selected for the pixel pₘₐₓ. If the maximum estimated disparity is 1.0, pₘₐₓ is pixel m. After computing the pixel pₘₐₓ, the pre-processing module 12 continues moving the search pixel until another pixel is reached whose observed disparity value is smaller than δₘᵢₙ. The next pixel on the line segment is then selected for pixel pₘᵢₙ. The search space is narrowed to the line segment from pₘₐₓ to pₘᵢₙ as shown in FIG. 8. For each pixel in the novel view, there is an epipolar line segment associated with it in a reference view. The above bounding computation may be done only once for a new viewpoint due to the coherence in the epipolar geometry, and every epipolar line segment uses this result.

By constraining the novel viewpoint to be on the same plane as the input camera array 20 and the new image plane to be parallel to the original image plane, the coherence in the epipolar geometry can be exploited to facilitate the view synthesis process.

For each pixel in the novel view, there is a corresponding epipolar line in the reference view Cᵤ, and it is parallel to CᵤC due to the configuration of the input camera array 20 relative to the novel view. The length of mbᵤ is equal to that of CᵤC, since Cm and Cᵤbᵤ are parallel rays. Thus, for each pixel in the novel view, its corresponding loosely bounded search segment (mbᵤ) is parallel to CᵤC and has a length of |CᵤC| as shown in FIG. 9. The pixel's observed disparity value only depends on the length of CᵤC and the pixel's position on the segment. Hence, in a reference view, every search segment (pₘₐₓpₘᵢₙ) for every pixel in the novel view is parallel to CᵤC and has constant length.

Since Cm and Cᵤbᵤ are parallel rays, point bᵤ and point m have the same image coordinates in the reference image and in the novel image, respectively. For any given pixel (x, y) in the novel image, the coordinates of the pixel, where the search starts in the reference image, can be computed. This can be done by offsetting the image coordinates (x, y) by a vector \vec{bᵤpₘₐₓ}. The coordinates of the end point can also be computed using another offset vector \vec{bᵤpₘᵢₙ}. Similarly, each point on the search segment pₘₐₓpₘᵢₙ can be represented using the pixel coordinates (x, y) in the novel view and a corresponding offset vector. All of these offset vectors may be pre-computed and stored in an offset vector array. The observed disparity values may also be pre-computed and stored in an observed disparity array since the observed disparity value of each pixel is a fraction of the length of the offset vector to |CᵤC|. Since all of the search segments on a reference image are parallel and have the same length, the two arrays are only computed once for a new viewpoint, and can be used for every pixel in the novel view.

This pre-computation provides an enhancement in performance, and the offset vectors can be used to easily locate candidate pixels in the reference image for each pixel in the novel view. This makes the method suitable for GPU-based implementation, since the pixel shaders can easily find the candidate pixels in the reference image by offsetting the texture coordinates of the current pixel being processed.

Accordingly, the pre-processing module 12 performs several functions. The pre-processing module 12 calculates offset vector arrays and corresponding observed disparity arrays. Two arrays are calculated for each reference or input image based on the location of the novel view. Each camera in the input camera array 20 may provide an input image. Alternatively, the input images may be provided by the storage unit 18 or by another suitable means (i.e. over a computer network or other suitable communication means if the image-based rendering system is implemented on an electronic device that can be connected to the communication means).

There are typically two kinds of artifacts that need to be corrected with this form of image-based rendering. The first type of artifact is known as a rubber-sheet artifact and the second type of artifact are holes that are caused by the visibility change. What is meant by visibility change is that some part of the scene is visible from some viewpoints while invisible from some others. In this way, the visibility is changing across the different viewpoints.

Previous methods use a fixed threshold value to detect the rubber sheet problem. Whenever F(pᵤ)×F(qᵤ)≦0 and |F(pᵤ)−F(qᵤ)|>t, where t is the threshold value and pᵤ and qᵤ are two consecutive pixels on the search segment in the reference image, no zero-crossing point will be returned since pᵤ and qᵤ are considered to be on two discontinuous regions [11]. This method fails when the novel viewpoint is very close to a reference view. In this case, |CᵤC| becomes very small and |F(pᵤ)| and |F(qᵤ)| will become large. Accordingly, the value of |F(pᵤ)−F(qᵤ)| may be larger than the threshold value t even if pᵤ and qᵤ are on a continuous surface.

To solve this problem, while generating the novel view, the view synthesis module 14 also applies an adaptive threshold as shown in equation 7.

$$adaptive threshold = \frac{t}{\vert {C}_{u} C \vert} \qquad ( 7 )$$

When |CᵤC| becomes small, the threshold becomes large accordingly. In this way, the rubber sheet problem (i.e. the scene discontinuities) can be detected more accurately. Accordingly, this module looks for pixels that cannot be colored using the information from the current image. If a pixel cannot be colored using all the reference images, it needs to be filled in as described below.

Although the backward search will normally succeed for most of the pixels in the novel view, there may still be some pixels that are not visible in any of the reference images and these pixels will appear as holes in the reconstructed/rendered image. To fill these holes, previous methods use a color-matching based view interpolation algorithm [11], which searches for the best match on the several reference images simultaneously based on color consistency. It is a slow process and requires several texture lookups for all reference images within a single rendering pass, and hence, the performance is poor. Instead, a heuristic method as described in [15] may be used by the artifact rejection module 16.

The holes occur at locations where there are scene discontinuities that can be detected by the rubber sheet test performed by the view synthesis module 14. Whenever a discontinuity is found between two consecutive pixels while generating a novel view, the algorithm employed by the view synthesis module 14 just outputs a zero-alpha pixel, which is a pixel whose alpha value is zero. Then the view synthesis module 14 continues searching the pixels since there is a possibility that the “hole pixel” may be visible in another reference view, and may be colored using a pixel from that reference image accurately. After the view synthesis module 14 is done, the resulting image may still contain some holes because these pixels are not visible in any of the reference images.

The artifact rejection module 16 then fills these holes. For each of these hole pixels, this module outputs the color of the pixel with a smaller estimated disparity value, i.e., the pixel farther from the center of projection. For example, in FIG. 3, a discontinuity is detected between pixels pᵤ and qᵤ. Since δ(pᵤ) is smaller than δ(qᵤ), the color of the pixel pᵤ is used to color the pixel m in the novel view. This is based on the assumption that the background surface continues smoothly from point pᵤ to point M. The pixel m may be colored using a local background color. As shown in test figures later on, the holes may be filled using the colors from the background as well.

The artifact rejection module 16 begins with one reference image. After searching the whole image for scene discontinuities, the artifact rejection module 16 continues searching the other reference images. Both the view synthesis module 14 and artifact rejection module 16 need to access only the current reference image, and thus can be implemented efficiently by processing several pixels in one image concurrently using appropriate hardware. Other reference images may need to be searched because the pixel may be occluded in one or more of the reference images.

Since the search process for each pixel in the novel view is independent of the others, parallel processing may be employed to accelerate the operation of the image-based rendering system 10. Current commodity graphics processing units, such as the ATI Radeon™ series [16] and the nVIDIA GeForce™ series [17], each provide a programmable per-vertex processing engine and a programmable per-pixel processing engine. These processing engines are often called the vertex shader and the pixel shader, respectively. The image-based rendering method 30 of the invention uses texture mapping to render the intermediate and final results and may use the vertex and pixel shaders to search for the zero-crossing points in the reference images.

The image-based rendering method 30 of the invention only requires images as input. During the pre-processing step 32, a disparity map is estimated for each of the reference images. Since the graphics hardware is capable of handling textures with four RGBA channels, the original color image may be stored in the RGB channels and the corresponding disparity map in the α channel of a texture map. Accordingly, the color of a pixel and its corresponding estimated disparity value can be retrieved using a single texture lookup, which saves bandwidth for accessing textures.

Prior to rendering a frame, an array of offset vectors and an array of observed disparity values are computed for each reference view in the pre-processing step 32. It is not easy to pass an entire array to the pixel shader due to the limitations of current GPUs. To solve this problem, the search process can be divided into multiple rendering passes. During each rendering pass, a texture-mapped rectangle is rendered and parallel projected into the output frame buffer of the GPU. The color for each pixel in the rectangle is computed within the pixel shader.

Accordingly, for a pixel (x, y) in the novel view, two consecutive candidate pixels pᵤ and qᵤ on the search segment in the reference image are evaluated during each rendering pass. The offset vectors for the pixels pᵤ and qᵤ are passed to the vertex shader. The vertex shader offsets the vertex texture coordinates by the offset vectors and obtains two new pairs of texture coordinates for each vertex. Then the new vertex texture coordinates are interpolated over the fragments in the rectangle. Based on these interpolated fragment texture coordinates, the pixel shader can now access the colors and the pre-estimated disparity values of pᵤ and qᵤ from the reference image. At the same time, the observed disparity values for the pixels pᵤ and qᵤ are passed to the pixel shader by the main program. If the pixels pᵤ and qᵤ satisfy the zero-crossing criterion, the pixel shader will output the weighted average of the two pixel colors to pixel (x, y) in the frame buffer; otherwise, a zero-alpha pixel is rendered. The weight for interpolation is computed based on the distance from the candidate pixel to the actual zero-crossing point. An α test may be executed by the view synthesis module 14 to render only those pixels whose a values are larger than zero. If a pixel fails the alpha test, it will not get rendered. In the next rendering pass, the offset vectors and the observed disparity values for the next candidate pair are passed to the shaders. In this way, candidate pixels are moving along the search segments. The number of rendering passes needed for searching in one reference image is |pₘₐₓpₘᵢₙ|−1 (in pixels).

In practice, the algorithm is only carried out for those pixels, whose search segments are totally within the current reference image. This can be done by testing whether the two endpoints of the search segment are inside the reference image. Otherwise, the shaders need to be programmed to avoid accessing pixels that are outside of the current reference image. The un-rendered part of the novel view will be processed using the other reference views using the method of the invention. The parallel processing is performed at the pixel level so when the novel view is being processed using one reference image, all of the pixels can be considered as being processed in parallel. However, the processing is sequential with regard to the reference views, meaning one reference image is processed at a time.

By constraining the novel camera to be on the plane of the input camera array 20, the coherence in the epipolar geometry can be exploited to facilitate the view synthesis process. Otherwise, all of the observed disparity values need to be computed in the GPUs and a pixel-moving algorithm is required in the GPUs as well. Computing the observed disparity values and “moving” pixels within the shaders may not be efficient with the current generation of GPUs.

The image-based rendering method 30 may be modified to output the disparity value of the zero-crossing point instead of the actual color to the frame buffer. This will produce a real-time depth map at the new viewpoint.

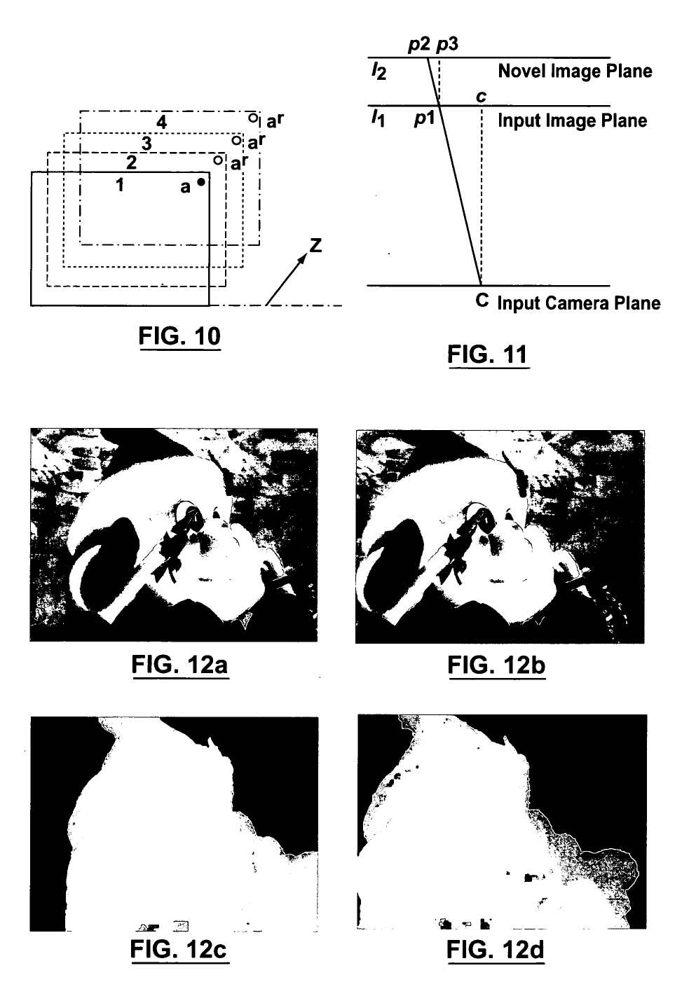

During rendering, texture-mapped rectangles are parallel projected and rendered at increasing distances to the viewer in order to solve the visibility problem. The visibility problem is that the pixel nearer to the viewer should occlude the pixel at the same location but farther away from the viewer. As shown in FIG. 10, four rectangles are rendered from near to far. If a pixel in the frame buffer has already been rendered at a certain depth (i.e. pixel a in rectangle 1), later incoming pixels at the same location (i.e. pixel a′ in rectangles 2, 3, and 4) will not be passed to the pixel shader for rendering because they are occluded by the previously rendered pixel. In this way, an early Z-kill is implemented in hardware and the search process for the current pixel in the novel view is stopped. Using this method, the first zero-crossing point is returned and bandwidth is not wasted for useless processing. A similar strategy is also used in a previous work [18]. If the back-to-front painter's algorithm is used, the desired performance may not be achieved since all of the pixels on the search segment will be processed. After searching all of the segments in one reference image, the algorithm continues to search the other reference images and composes the results together. With the depth test presented herein, a pixel whose color has already been decided will not be processed again.

There may still be some holes in the resulting rendered image after searching all of the reference images. The hole-filling method discussed earlier may be performed in the GPUs to remove the holes in the resulting rendered image. To fill the holes, another group of texture-mapped rectangles are parallel projected and rendered at increasing distances using a hole-filling pixel shader. In order to pass only those “holes” to the shaders, these rectangles are selected to be farther away from the viewer than those rectangles that were rendered previously. The pixel shader is programmed to output the color of the pixel with the smaller estimated disparity value whenever a discontinuity at two consecutive pixels is detected.

Although the image-based rendering method 30 constrains the new viewpoint to be on the plane of the input camera array 20, a zoom effect can still be achieved by changing the focal length of the camera. As shown in FIG. 11, I₁ is a novel view on the input image plane and I₂ is a zoom-in view. Rendering pixel p2 in I₂ is equivalent to rendering pixel p1 in I₁. Accordingly, when searching for the zero-crossing point for p2, the texture coordinates of p1 in I₁ which are the same as those of p3 in I₂, may be used to locate the candidate pixels. The texture coordinates of p3 in I₂ can be obtained by offsetting p2, the current pixel being processed, by a vector of \vec{p2p3}, which can be computed based on the similarity of Δp1p2p3 and ΔCp1c. The effect of rotating the camera may be produced by a post-warp step such as that introduced in [9].

The image-based rendering system 10 may be implemented using an AMD 2.0 GHz machine with 3.0 GB of memory, running Windows XP Professional. An ATI 9800 XT graphics card that has 256 MB video memory may be used to support the pixel shader and vertex shader functionalities. The system may further be implemented using OpenGL (i.e. the vertex shader and pixel shader can be programmed using the OpenGL Shading Language [19]).

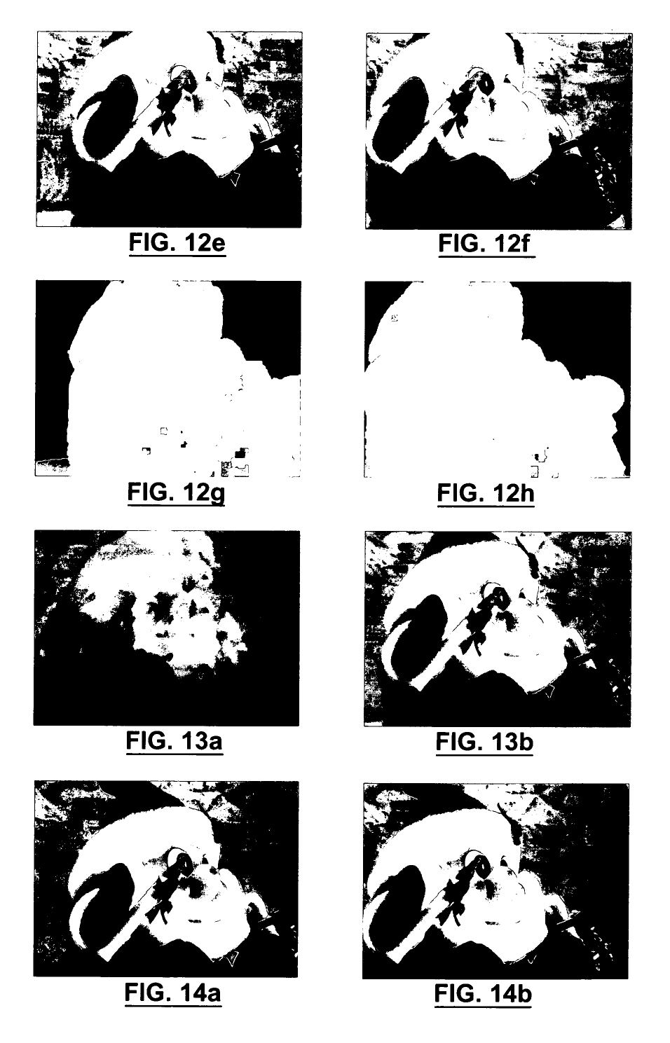

The image-based rendering system 10 was tested using two scenes. The first scene that was rendered was the Santa Claus scene. The input images were rectified and each had a resolution of 636×472 pixels. FIGS. 12a-h show four reference images with corresponding disparity maps estimated using the genetic-based stereo estimation method [12]. Median filtering was applied to the disparity maps to reduce noise while preserving edges. FIG. 13a shows the linear interpolation result in the middle of the four reference images of FIGS. 12a, 12b, 12e and 12f. FIG. 13b shows the resulting rendered image at the same viewpoint as that of FIG. 13a using the image-based rendering system 10. FIGS. 14c-f show the rendered results at four different viewpoints inside the space bounded by the four reference views in FIGS. 12a (14a), 12b (14b), 12e (14g) and 12f (14h). In each case, the novel view is successfully reconstructed.

Table 1 shows the frame rates for implementing the image-based rendering system 10 using solely a CPU-based approach and using a GPU-based approach. All of the frame rates were obtained at the same novel viewpoint in the middle of four nearby reference views. For viewpoints closer to one of the reference views, the frame rates were even higher. From the table, it can be seen that using a GPU can accelerate the image-based rendering method 30 considerably. For a large output resolution, the CPU-based approach fails to reconstruct the novel view in real time while the GPU-based approach can still produce the result at an interactive frame rate. The results indicate that the image-based rendering method 30 may be performed in parallel by a GPU.

TABLE 1
Frame rates obtained using a CPU-based and a GPU-based approach
for the Santa Claus scene (input resolution is 636 × 472).

| Output Resolution | CPU Frame Rate | GPU Frame Rate |
|---|---|---|
| 636 × 472 | 4 fps | 16 fps |
| 318 × 236 | 14 fps | 51 fps |
| 159 × 118 | 56 fps | 141 fps |

A more densely sampled Santa Claus scene was also rendered. The maximum difference between the coordinates of two corresponding points in adjacent input images is 51 pixels in this scene, while it is 102 pixels in the previous scene. FIG. 15a shows the rendering result for this scene. It can be seen that the result does not improve much compared to the result rendered from a more sparsely sampled scene (FIG. 15b). However, the frame rate increases from 54 frames per second to 78 frames. This is because the search space used in the image-based rendering method 30 depends on the distance between the novel viewpoint and the reference viewpoint. If two nearby reference images are very close to each other, the search segment will be very short, and thus, the searching will be fast. Accordingly, the denser the sampling (i.e. the closer the reference images), the higher the frame rate.

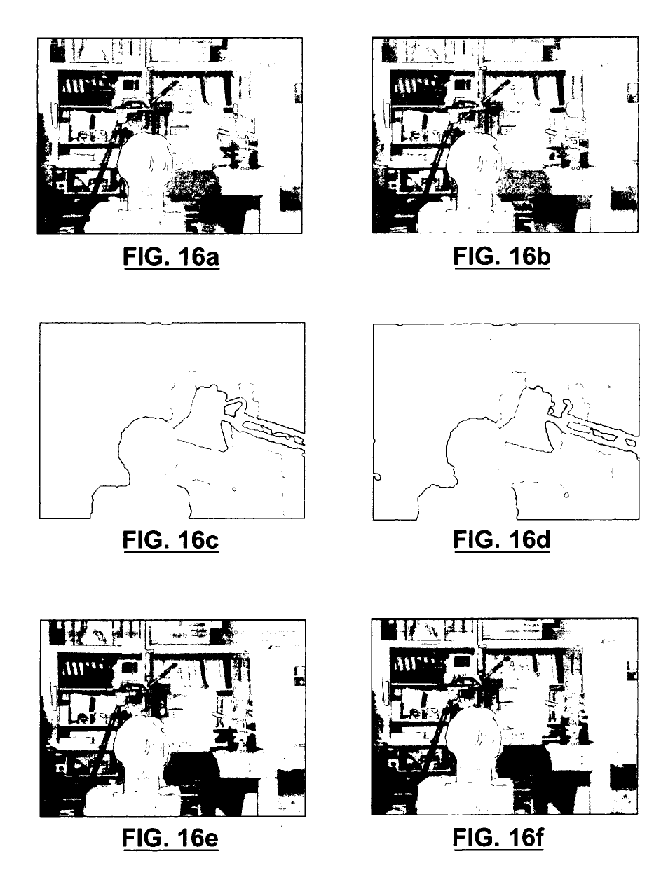

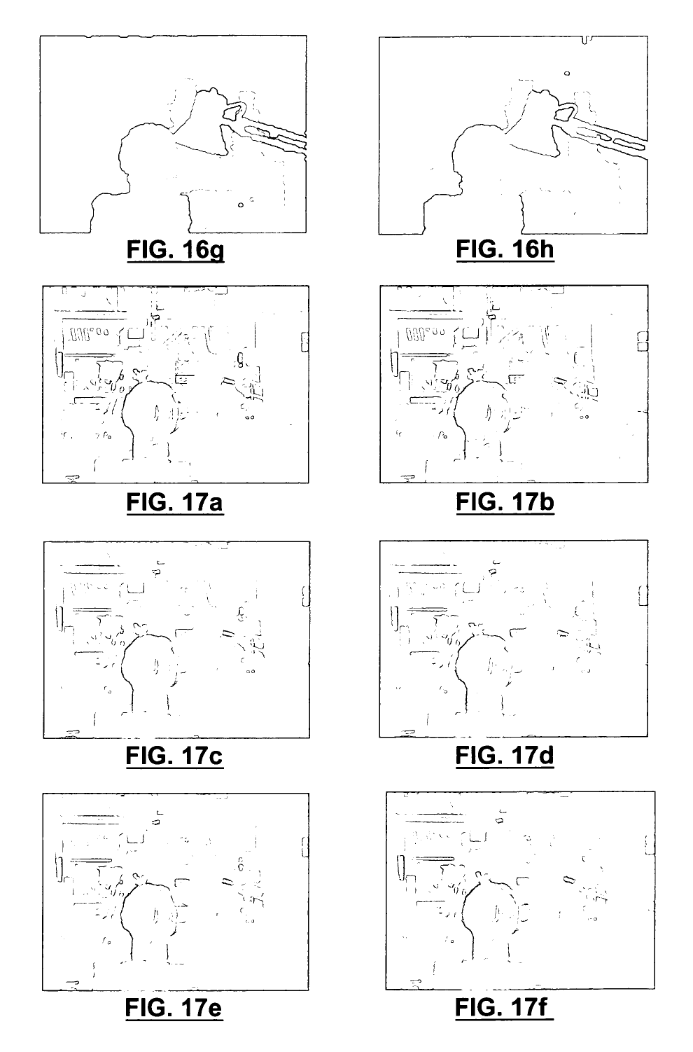

Another scene that was rendered was the “head and lamp” scene. The maximum difference between the coordinates of two corresponding points in adjacent input images is 14 pixels. Four reference views with corresponding disparity maps are shown in FIGS. 16a-h. FIGS. 17c-f show four synthesized views inside the space bounded by the four reference views in FIGS. 16a (17a), 16b (17b), 16e (17g) and 16f (17h). The results demonstrate that the head and lamp scene can be reconstructed successfully with the image-based rendering method 30.

For a viewpoint in the middle of four reference views, the image-based rendering method 30 can render 14 frames per second in a purely CPU-based approach and 89 frames per second in a GPU-based approach. FIG. 18a shows a linear interpolation result from the four reference views in FIGS. 16a, 16b, 16e and 16f. FIG. 18b shows the synthesized result using the image-based rendering method 30 at the same viewpoint on the same reference views.

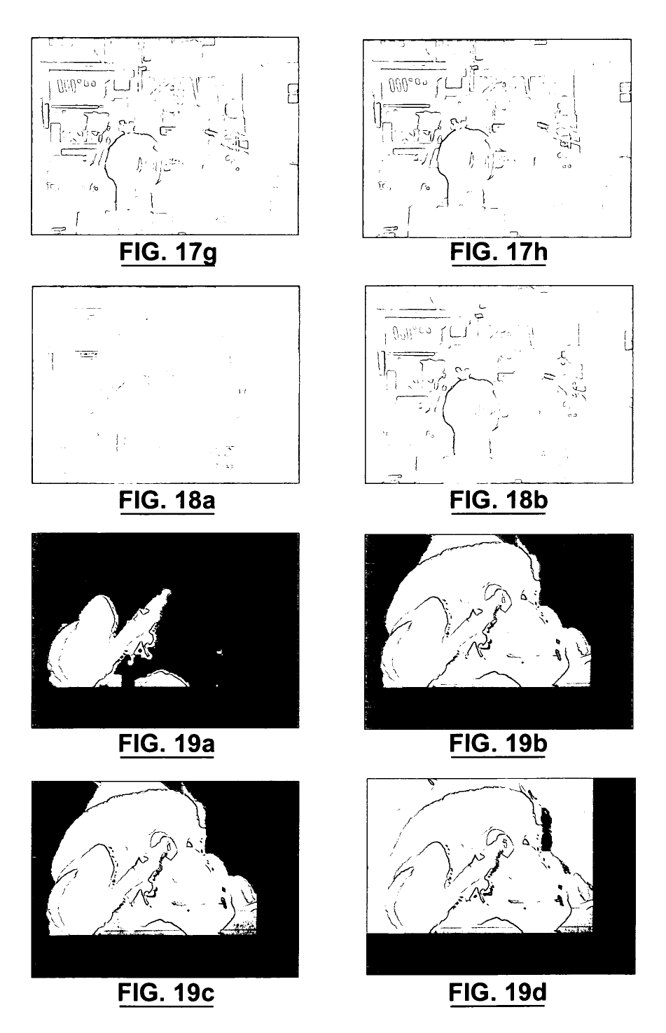

FIGS. 19a-d show some intermediate results in the frame buffer when synthesizing a novel view using one reference image. With one reference image, one may obtain a partial rendering result. If the view synthesis step 34 stops after a small number of rendering passes, an intermediate result is obtained. More and more pixels will be rendered when the number of rendering passes increases. Since the length of the search segment is 41 pixels in this example, the complete result using one reference view is generated after 40 rendering passes. The holes (black areas) will be filled either by searching the other reference views or by using the hole-filling method in artifact rejection step 36.

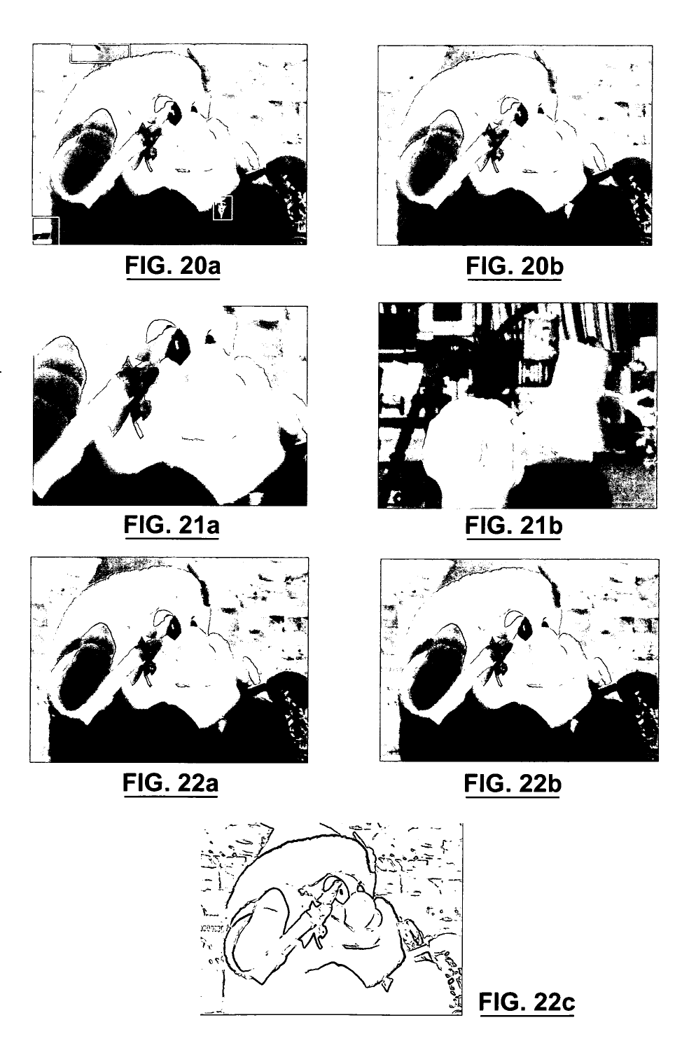

FIGS. 20a and 20b show the rendering results without and with hole-filling. The holes are mainly in the background area of the scene, and may be filled by using the local background surface color. Since there are only a small number of pixels to be filled (i.e. the black area in FIG. 20a), this step can be done efficiently. For an output resolution of 318×236 pixels, and if the novel view is in the middle of the four reference views, the frame rate is about 52 frames per second without hole-filling and 51 frames with hole-filling.

FIGS. 21a and 21b show zoom-in results for the Santa Claus scene and the head and lamp scene respectively (i.e. by changing the focal length of the virtual camera).

To evaluate the accuracy of the reconstructed view, a difference image may be computed between a novel view generated using the image-based rendering method 30 and the captured ground truth (see FIGS. 22a-c). The difference shown in FIG. 22c is very small (the darker the pixel, the larger is the difference).

In general, the number of reference input images may be preferably four. However, the invention may work with three reference views and sometimes as few as two reference views depending on the scene. The number of reference input images may also be larger than four.

The image-based rendering system 10 includes several modules for processing the reference images. In one embodiment, the modules may be implemented by dedicated hardware such as a GPU with appropriate software code that may be written in C++ and OpenGL (i.e. using the OpenGL Shading Language). The computer programs may comprise modules or classes, as is known to those skilled in object oriented programming. The invention may also be easily implemented using other high level shading languages on other graphics hardware that do not support the OpenGL Shading Language.

The image-based rendering system and method of the invention uses depth information to facilitate the view synthesis process. In particular, the invention uses implicit depth (e.g. disparity) maps that are estimated from images. Although the disparity maps cannot be used as accurate geometry, they can still be used to facilitate the view synthesis. The invention may also use graphics hardware to accelerate rendering. For instance, searching for zero-crossing points may be carried out in a per-pixel processing engine, i.e., the pixel shader of current GPUs. The invention can also render an image-based object or scene at a highly interactive frame rate.

In addition, advantageously, the invention uses only a group of rectified images as input. Re-sampling is not required for the input images. This simplifies the data acquisition process. The invention can reconstruct accurate novel views for a sparsely sampled scene with the help of roughly estimated disparity maps and a backward search method. The number of samples to guarantee an accurate novel view is small. In fact, it has been found that a denser sampling will not improve the quality much. In addition, with the programmability of current GPUs, a high frame rate can be achieved using the backward method discussed herein. In particular, since the rendering process is similar for each output pixel, a single program may be used with all of the output pixels. This processing may be done in parallel meaning that several pixels can be processed at the same time. Furthermore, with the invention, free movements of the cameras in the input camera array may be possible if more computations are performed in the vertex and pixel shaders of the GPU. In addition, with a depth test, an early Z-kill can also help to guarantee the correctness of the results and to increase performance.

Another advantage of the invention is that, since the novel view of the scene is rendered directly from the input images, the rendering rate is dependent on the output resolution instead of on the complexity of the scene. In addition, the backward search process used in the invention will succeed for most of the pixels in the novel view unless the pixel is not visible in all of the nearby four reference views. Therefore, the inventive IBR method will result in significantly fewer holes as compared with previous forward mapping methods, which will generate more holes in the final rendering results even if some pixels in the holes are visible in the reference views.

The invention may be used in products for capturing and rendering 3D environments. Applications include 3D photo documentation of important historical sites, crime scenes, and real estates; training, remote education, tele-presence or tele-immersion, and some entertainment applications, such as video games and movies. Accordingly, individuals who are interested in tele-immersion, building virtual tours of products or of important historical sites, immersive movies and games will find the invention useful.

It should be understood that various modifications can be made to the embodiments described and illustrated herein, without departing from the invention, the scope of which is defined in the appended claims.

### REFERENCES

[1] M. Levoy and P. Hanrahan. Light field rendering. In SIGGRAPH'96, pages 31-42. ACM Press, 1996.
[2] S. J. Gortler, R. Grzeszczuk, R. Szeliski, and M. F. Cohen. The lumigraph. In SIGGRAPH'96, pages 43-54. ACM Press, 1996.
[3] L. McMillan. An image-based approach to three-dimensional computer graphics. Ph.D. Dissertation. UNC Computer Science Technical Report TR97-013, April 1997.
[4] L. McMillan and G. Bishop. Plenoptic modeling: An image-based rendering system. In SIGGRAPH'95, pages 39-46. ACM Press, 1995.
[5] M. M. Oliveira and G. Bishop. Image-based objects. In Proceedings of the 1999 symposium on Interactive 3D graphics, pages 191-198. ACM Press, 1999.
[6] M. M. Oliveira, G. Bishop, and D. McAllister. Relief texture mapping. In SIGGRAPH'00, pages 359-368. ACM Press/Addison-Wesley Publishing Co., 2000.
[7] J. Kautz and H. P. Seidel. Hardware accelerated displacement mapping for image-based rendering. In Graphics Interface 2001, pages 61-70, 2001.
[8] S. E. Chen and L. Williams. View interpolation for image synthesis. In SIGGRAPH'93, pages 279-288. ACM Press, 1993.
[9] S. M. Seitz and C. R. Dyer. View morphing. In SIGGRAPH'96, pages 21-30. ACM Press, 1996.
[10] D. Scharstein. Stereo vision for view synthesis. In IEEE Computer Society Conference on Computer Vision and Pattern Recognition, CVPR'96, pages 852-858, 1996.
[11] M. Gong and Y. H. Yang. Camera field rendering for static and dynamic scenes. Graphical Models, Vol. 67, 2005, pp. 73-99.
[12] M. Gong and Y. H. Yang. Genetic based stereo algorithm and disparity map evaluation. Int. J. Comput. Vision, 47(13): 63-77, 2002.
[13] R. Yang and M. Pollefeys. Multi-resolution real-time stereo on commodity graphics hardware. In Proceedings of IEEE Conference on Computer Vision and Pattern Recognition 2003, June 2003.
[14] G. E. Blelloch. Vector models for data-parallel computing. The MIT Press, 1990.
[15] W. R. Mark, L. McMillan, and G. Bishop. Post-rendering 3D warping. In Proceedings of the 1997 Symposium on Interactive 3D Graphics, pages 7-16. ACM Press, 1997.
[16] ATI. http://www.ati.com/developer.
[17] nVIDIA. http://developer.nvidia.com/page/home.
[18] A. Sherbondy, M. Houston, and S. Napel. Fast volume segmentation with simultaneous visualization using programmable graphics hardware. In IEEE Visualization 2003, 2003.
[19] J. Kessenich, D. Baldwin, and R. Rost. The OpenGL shading language, version 1.051, February 2003.

1. An image-based rendering system for rendering a novel image from several reference images, the system comprising:
a) a pre-processing module for pre-processing at least two of the several reference images and providing pre-processed data;
b) a view synthesis module connected to the pre-processing module for synthesizing an intermediate image from the at least two of the reference images and the pre-processed data; and,
c) an artifact rejection module connected to the view synthesis module for correcting the intermediate image to produce the novel image.

2. The system of claim 1, wherein the several reference images are taken by cameras in an input camera array arranged in a plane and the viewpoint from which the novel image is taken from a location in the input camera array plane.

3. The system of claim 2, wherein for each of at least two selected reference images, the pre-processing module estimates a disparity map and computes an array of observed disparity values and an array of offset vectors based on the location of the novel viewpoint with respect to the at least two selected reference images.

4. The system of claim 3, wherein the pre-processing module computes the array of observed disparity values by using a smaller search space being defined by a maximum and a minimum bounding pixel, wherein the maximum bounding pixel is the last pixel on a corresponding epipolar line segment having an observed disparity value larger than or equal to a pre-defined maximum estimated disparity value, and the minimum bounding pixel is the first pixel on the corresponding epipolar line segment having an observed disparity value smaller than or equal to a pre-defined minimum estimated disparity value when a search pixel is moving from the pixel with the largest observed disparity value to the pixel with the smallest observed disparity value.

5. The system of claim 4, wherein offset vectors for a given pixel bᵤ with respect to the novel viewpoint are based on the given pixel bᵤ and the maximum and minimum bounding pixels pₘₐₓ and pₘᵢₙ according to vectors \vec{bᵤpₘₐₓ} and \vec{bᵤpₘᵢₙ}, wherein the location of the given pixel bᵤ is determined by the intersection of a first ray from the novel viewpoint to an image plane through a point so that the first ray is parallel to a second ray from one of the selected reference images that intersects the image plane at a second pixel corresponding to the given pixel.

6. The system of claim 2, wherein the view synthesis module generates the intermediate image by applying a backward search method to a plurality of pixels in the intermediate image in parallel.

7. The system of claim 2, wherein the view synthesis module detects and locates holes in the intermediate image and the artifact rejection module fills the holes in the intermediate image to produce the novel image.

8. The system of claim 7, wherein the view synthesis module applies an adaptive threshold
$$\frac{t}{\vert {C}_{u} C \vert}$$
for detecting the holes where t is a constant threshold value, Cᵤ is the center of projection of the reference view and C is the center of projection of the novel view.

9. An image-based rendering method for rendering a novel image from several reference images, the method comprising:
a) pre-processing at least two of the several reference images and providing pre-processed data;
b) synthesizing an intermediate image from the at least two of the reference images and the pre-processed data; and,
c) correcting the intermediate image and producing the novel image.

10. The method of claim 9, wherein the method further comprises generating the several reference images with an input camera array arranged in a plane and the viewpoint from which the novel image is taken from a location in the input camera array plane.

11. The method of claim 10, wherein for each of at least two selected reference images, pre-processing includes estimating a disparity map and computing an array of observed disparity values and an array of offset vectors based on the location of the novel viewpoint with respect to the at least two selected reference images.

12. The method of claim 11, wherein computing the array of observed disparity values includes using a smaller search space being defined by a maximum and a minimum bounding pixel, wherein the maximum bounding pixel is the last pixel on a corresponding epipolar line segment having an observed disparity value larger than or equal to a pre-defined maximum estimated disparity value, and the minimum bounding pixel is the first pixel on the corresponding epipolar line segment having an observed disparity value smaller than or equal to a pre-defined minimum estimated disparity value when a search pixel is moving from the pixel with the largest observed disparity value to the pixel with the smallest observed disparity value.

13. The method of claim 12, wherein the method includes defining offset vectors for a given pixel bᵤ with respect to the novel viewpoint based on the given pixel bᵤ and the maximum and minimum bounding pixels pₘₐₓ and pₘᵢₙ according to vectors \vec{bᵤpₘₐₓ} and \vec{bᵤpₘᵢₙ} wherein the location of the given pixel bᵤ is determined by the intersection of a first ray from the novel viewpoint to an image plane through a point so that the first ray is parallel to a second ray from one of the selected reference images that intersects the image plane at a second pixel corresponding to the given pixel.

14. The method of claim 10, wherein synthesizing the intermediate image includes applying a backward search method to a plurality of pixels in the intermediate image in parallel.

15. The method of claim 10, wherein correcting the intermediate image includes:
a) detecting and locating holes in the intermediate image and producing an image with holes; and,
b) filling holes in the intermediate image to produce the novel image.

16. The method of claim 15, wherein detecting the holes includes applying an adaptive threshold
$$\frac{t}{\vert {C}_{u} C \vert}$$
where t is a constant threshold value, Cᵤ is the center of projection of the reference view and C is the center of projection of the novel view.
